(19) United States
(12) Patent Application Publication
(10) Pub. No.: US 2026/0133299 A1
(43) Pub. Date: May 14, 2026

(54) LIDAR DEVICE AND METHOD OF OPERATING THE SAME

(71) Applicant: SAMSUNG ELECTORNICS CO., LTD., Suwon-si (KR)

(72) Inventors: Sangyun PARK, Suwon-si (KR); Byunghoon Ko, Suwon-si (KR); Jinwoo Choi, Suwon-si (KR); Jisan Lee, Suwon-si (KR)

(73) Assignee: SAMSUNG ELECTORNICS CO., LTD., Suwon-si (KR)

(21) Appl. No.: 19/222,322

(22) Filed: May 29, 2025

(30) Foreign Application Priority Data
Nov. 13, 2024 (KR) 10-2024-0160973

(51) Int. Cl. G01S 7/4911; G01S 17/58

(52) U.S. Cl. CPC G01S 7/4911; G01S 17/58

(57) ABSTRACT

A light detection and ranging (LiDAR) device includes a transmission unit configured to project a transmission signal toward an object, an optical element between the transmission unit and the object and configured to partially reflect the transmission signal projected by the transmission unit, a reception unit including at least one optical interferometer configured to generate a first optical signal by mixing a first reception signal reflected from the object with the transmission signal and a second optical signal by mixing a second reception signal reflected from the optical element with the transmission signal, and at least one photodetector (PD) configured to convert the first optical signal and the second optical signal into a first beat signal and a second beat signal, respectively, and a processor configured to generate a clock signal based on the second beat signal and correct the first beat signal based on the clock signal.

### CROSS-REFERENCE TO RELATED APPLICATION

This application is based on and claims priority under 35 U.S.C. § 119 to Korean Patent Application No. 10-2024-0160973, filed on Nov. 13, 2024, in the Korean Intellectual Property Office, the disclosure of which is incorporated by reference herein in its entirety.

### BACKGROUND

### 1. Field

The disclosure relates to a light detection and ranging (LiDAR) device and a method of operating the LiDAR device, and more particularly, to a LIDAR device employing a frequency modulated continuous wave (FMCW) driving method and a method of operating the LiDAR device.

### 2. Description of Related Art

LIDAR devices are used in various fields such as unmanned vehicles, autonomous driving vehicles, drones, robots, and precise measurement devices. For example, a LiDAR device employing an FMCW driving method may be used as a sensor to acquire, in real time, four-dimensional information, including distance and velocity information, on an object ahead by using a signal with a continuously varying frequency.

For example, an FMCW-based LiDAR device may measure its velocity and the distance to a target by projecting a signal with a time-varying frequency onto the target, receiving a signal reflected from the target, generating a beat frequency based on a time delay difference between the signals, and analyzing the beat frequency.

### SUMMARY

Provided are a LiDAR device and a method of operating the LiDAR device.

Aspects of the disclosure are not limited thereto, and other aspects of the disclosure will be apparently understood by those skilled in the art through the following description.

Additional aspects will be set forth in part in the description which follows and, in part, will be apparent from the description, or may be learned by practice of one or more embodiments.

According to one or more embodiments, there is provided a light detection and ranging (LiDAR) device including a transmission unit configured to project a transmission signal toward an object, an optical element between the transmission unit and the object, the optical element being configured to partially reflect the transmission signal projected by the transmission unit, a reception unit including at least one optical interferometer configured to generate a first optical signal by mixing a first reception signal reflected from the object with the transmission signal and a second optical signal by mixing a second reception signal reflected from the optical element with the transmission signal, and at least one photodetector (PD) configured to convert the first optical signal and the second optical signal into a first beat signal and a second beat signal, respectively, and a processor configured to generate a clock signal based on the second beat signal and correct the first beat signal based on the clock signal.

The processor may be further configured to extract the second beat signal from measurement results of the at least one PD based on a bandpass filter or a low-pass filter, and generate the clock signal based on the extracted second beat signal.

The processor may be further configured to generate the clock signal by thresholding the extracted second beat signal and then multiplying a frequency of the extracted second beat signal.

The processor may be further configured to generate the clock signal by multiplying a frequency of the extracted second beat and then thresholding the extracted second beat signal.

The processor may be further configured to convert measurement results of the at least one PD into a digital signal, extract the first beat signal and the second beat signal from the digital signal based on a software filter, and correct the first beat signal based on the extracted second beat signal.

The processor may be further configured to correct the first beat signal by removing, based on the clock signal, distortion from measurement results of the at least one PD.

The processor may be further configured to control a bandpass filter or a high-pass filter to extract the first beat signal from measurement results of the at least one PD.

The processor may be further configured to correct the extracted first beat signal by removing distortion from the extracted first beat signal based on the clock signal.

The reception unit may further include an optical delay line configured to increase a frequency of the second beat signal.

The processor may be further configured to measure at least one of a distance from the LiDAR device to the object and a velocity of the object based on the corrected first beat signal.

The transmission unit may be further configured to modulate a frequency of the transmission signal.

According to another aspect of one or more embodiments, there is provided a method of operating a light detection and ranging (LiDAR) device, the method including projecting, by a transmitting unit of the LiDAR device, a transmission signal toward an object, generating, by at least one optical interferometer of the LiDAR device, a first optical signal by mixing a first reception signal reflected from the object with the transmission signal, and a second optical signal by mixing a second reception signal reflected from an optical element with the transmission signal, converting, by at least one photodetector (PD) of the LiDAR device, the first optical signal and the second optical signal respectively into a first beat signal and a second beat signal, generating a clock signal based on the second beat signal, and correcting the first beat signal based on the clock signal, wherein the optical element is between a transmission unit and the object, the optical element being configured to partially reflect the transmission signal.

The generating of the clock signal based on the second beat signal may include extracting, by a bandpass filter or a low-pass filter, the second beat signal from measurement results of the at least one PD, and generating the clock signal based on the extracted second beat signal.

The generating of the clock signal based on the extracted second beat signal may be performed by thresholding the extracted second beat signal and then multiplying a frequency of the extracted second beat signal.

The generating of the clock signal based on the extracted second beat signal may be performed by multiplying a frequency of the extracted second beat signal and thresholding the extracted second beat signal.

The correcting of the first beat signal based on the clock signal may be performed by removing, based on the clock signal, distortion from measurement results of the at least one PD.

The correcting of the first beat signal based on the clock signal may include extracting, by a bandpass filter or a high-pass filter, the first beat signal from measurement results of the at least one PD, and removing distortion from the extracted first beat signal based on the clock signal to correct the first beat signal.

The method may further include increasing, by an optical delay line, a frequency of the second beat signal.

The method may further include measuring at least one of a distance from the LiDAR device to the object and a velocity of the object based on the corrected first beat signal.

The method may further include modulating a frequency of the transmission signal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a view illustrating a transmission signal and a reception signal each having a linearly increasing and decreasing frequency, and beat signals corresponding to the transmission signal and the reception signal;

FIG. 1B is a view illustrating a transmission signal and a reception signal, each having a non-linearly increasing and decreasing frequency;

FIG. 1C is a graph illustrating characteristics of a beat signal generated from the transmission signal and the reception signal shown in FIG. 1B;

FIG. 2 is a view illustrating a light detection and ranging (LiDAR) device according to one or more embodiments;

FIG. 3 is a set of graphs illustrating a first reception signal and a second reception signal received by the LiDAR device shown in FIG. 2, and a first beat signal and a second beat signal corresponding to the first reception signal and the second reception signal;

FIG. 4 is a view illustrating a method of correcting a first beat signal using a clock signal;

FIG. 5 is a flowchart illustrating how a LIDAR device shown in FIG. 4 corrects a first beat signal;

FIG. 6 is a set of graphs illustrating a method of generating a clock signal and a method of correcting a first beat signal;

FIG. 7 is a set of graphs illustrating characteristics of a first beat signal before and after the first beat signal is corrected;

FIG. 8A is a view illustrating a LIDAR device according to another embodiment;

FIG. 8B is a view illustrating a LIDAR device according to another embodiment;

FIG. 9 is a view illustrating the LiDAR device of FIG. 8B with an added optical delay line; and

FIG. 10 is a set of graphs illustrating characteristics of a beat signal generated in the LiDAR device shown in FIG. 9.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Throughout the disclosure, the expression “at least one of a, b, and c” indicates only a, only b, only c, both a and b, both a and c, both b and c, or all of a, b, and c.

The terms used in the disclosure are general terms currently widely used in the art in consideration of functions regarding the disclosure, but the terms may vary according to the intention of those of ordinary skill in the art, precedents, or new technology in the art. Also, some terms may be arbitrarily selected by the applicant, and in this case, the meaning of the selected terms will be described in the detailed description of the disclosure. Thus, the terms used herein should not be construed based on only the names of the terms but should be construed based on the meaning of the terms together with the description throughout the present disclosure.

In the following descriptions of embodiments, when a portion or element is referred to as being connected to another portion or element, the portion or element may be directly connected to the other portion or element, or may be electrically connected to the other portion or element with intervening portions or elements being therebetween. The terms of a singular form may include plural forms unless otherwise mentioned. It will be further understood that the terms “comprises” and/or “comprising” used herein specify the presence of stated features or elements, but do not preclude the presence or addition of one or more other features or elements.

In the following descriptions of the embodiments, expressions or terms such as “constituted by,” “formed by,” “include,” “comprise,” “including,” and “comprising” should not be construed as always including all specified elements, processes, or operations, but may be construed as not including some of the specified elements, processes, or operations, or further including other elements, processes, or operations.

Although terms including ordinal numbers such as “first” and “second” may be used herein to describe various elements, these elements should not be limited by these terms. These terms are only used to distinguish one element from element.

The following descriptions of the embodiments should not be construed as limiting the scope of the disclosure, and modifications or changes that could be easily made from the embodiments by those of ordinary skill in the art should be construed as being included in the scope of the disclosure. Hereinafter, embodiments will be described with reference to the accompanying drawings.

The embodiments may be implemented as software that includes one or more instructions stored in a storage medium that is readable by a machine such as a light detection and ranging (LiDAR) device. For example, a processor of the machine (e.g., a LiDAR device) may retrieve at least one instruction from among the one or more instructions stored in the storage medium and may execute the at least one instruction. This enables the machine to perform at least one function according to the retrieved at least one instruction. The one or more instructions may include code generated by a compiler or code executable by an interpreter. The storage medium (machine-readable storage medium) may be provided in the form of a non-transitory storage medium. Here, the expression “non-transitory” merely indicates that the storage medium is a tangible device and does not include signals (e.g., electromagnetic waves). The expression “non-transitory” does not distinguish between a case in which data is semi-permanently stored in the storage medium and a case in which data is temporarily stored in the storage medium.

The processor may be electrically or operably connected to components of a LiDAR device and may control the overall operation of the LiDAR device. For example, the process may perform embodiments described below by controlling operations of the components of the LiDAR device.

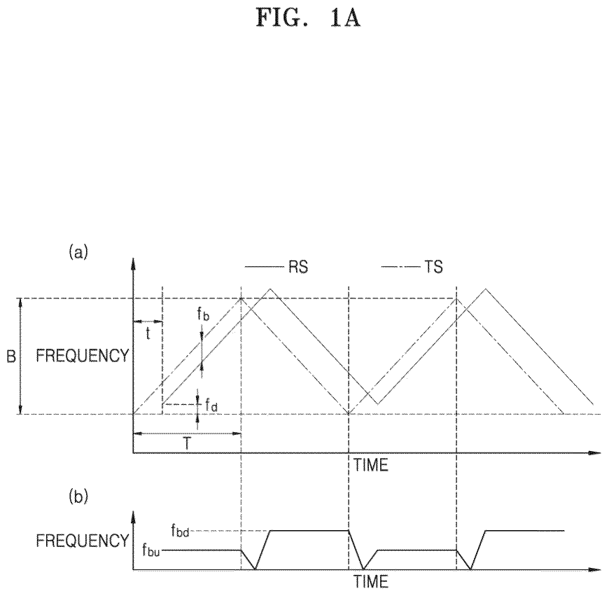

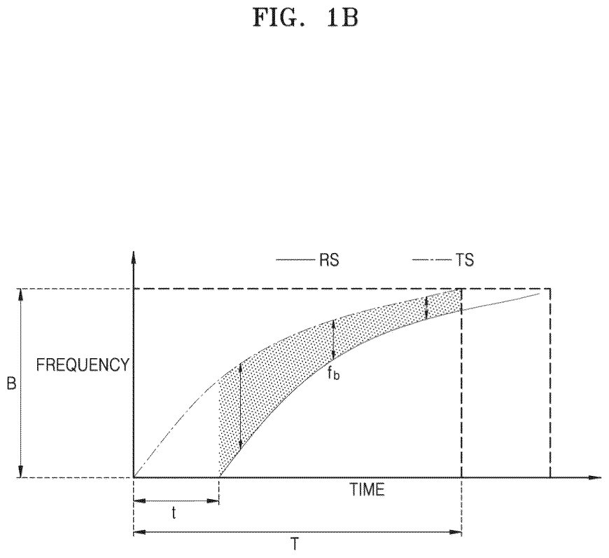

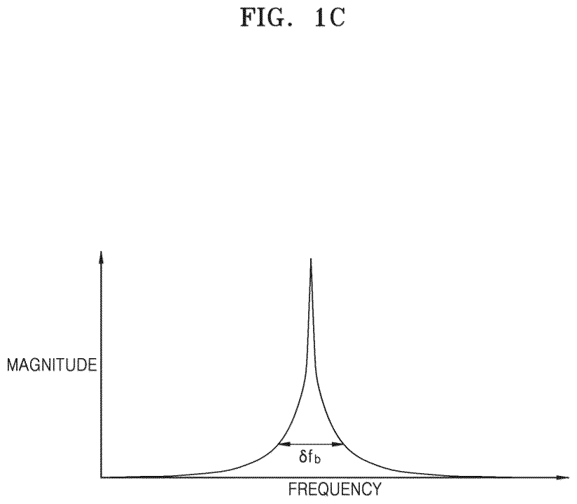

FIG. 1A is a view illustrating a transmission signal TS and a reception signal RS each having a linearly increasing and decreasing frequency, and beat signals f_{bu} and f_{bd} corresponding to the transmission signal TS and the reception signal RS. FIG. 1B is a view illustrating a transmission signal TS and a reception signal RS each having a non-linearly increasing and decreasing frequency. FIG. 1C is a graph illustrating characteristics of a beat signal fb generated from the transmission signal TS and the reception signal RS shown in FIG. 1B.

Referring to FIGS. 1A to 1C, a transmission signal used in a LIDAR device employing a frequency modulated continuous wave (FMCW) driving method may be a FMCW signal having a frequency varying linearly or non-linearly over time.

In graph (a) of FIG. 1A, the transmission signal TS and the reception signal RS, each having a linearly increasing and decreasing frequency, are indicated with a one-dot chain line and a solid line, respectively. In graph (a), B and T refer to a modulation bandwidth and a modulation period, respectively. According to one or more embodiments, the modulation bandwidth refers to the range of frequency variation in a transmission signal TS and may be a difference between maximum frequency and minimum frequency of the transmission signal TS. According to one or more embodiments, the modulation period refers to a period of time required to more fully modulate the frequency of a transmission signal TS and may be a period of time needed for the transmission signal TS to complete a single frequency sweep (for example, one up-chirp or one down-chirp).

When the frequency of a transmission signal TS projected from the LIDAR device toward an object increases or decreases linearly, the frequency of a reception signal RS reflecting from the object and returning to the LiDAR device may also increase or decrease linearly.

Because there is a time delay t between the time the transmission signal TS is transmitted from the LiDAR device and the time the reception signal RS is detected by the LiDAR device, a constant frequency difference (beat signal fb) may be between the transmission signal TS and the reception signal RS. In addition, relative distance and velocity variations between the LiDAR device and the object may cause frequency variations corresponding to the Doppler frequency fa between the transmission signal TS and the reception signal RS.

Therefore, a beat signal fb generated by the interference between the transmission signal TS and the reception signal RS may have a constant frequency. According to one or more embodiments, beat signal may be a frequency difference generated by the mixing of a transmission signal TS and a reception signal RS and may be a signal with a beat frequency. For example, a beat signal may be a signal generated by the mixing of the transmission signal TS and the reception signal RS, and a beat frequency may refer to the frequency of the beat signal.

Graph (b) of FIG. 1A illustrates up-beat signals f_{bu} and down-beat signals f_{bd} generated from the transmission signal TS and the reception signal RS. The up-beat signals f_{bu} may indicate a beat frequency corresponding to up-chirps, and the down-beat signals f_{bd} may indicate a beat frequency corresponding to down-chirps. The up-beat signals f_{bu} and the down-beat signals f_{bd} may satisfy Equations 1 and 2 below.

$${f}_{b u} = {f}_{b} - {f}_{d} \qquad [ Equation 1 ]$$

$${f}_{b d} = {f}_{b} + {f}_{d} \qquad [ Equation 2 ]$$

In addition, the Doppler frequency fa may be proportional to the relative velocity (v) of the object with respect to the LiDAR device and may be inversely proportional to the wavelength λ of the transmission signal TS, as expressed in Equation 3 below.

$${f}_{d} = \frac{2 v}{λ} \qquad [ Equation 3 ]$$

Therefore, a distance R to the object from the LiDAR device may be proportional to the average of the up-beat signals f_{bu} and the down-beat signals f_{bd}, and a difference between the up-beat signals f_{bu} and the down-beat signals f_{bd} may be proportional to the relative velocity (v) between the LiDAR device and the object. In Equation 4 below, slope may refer to a rate at which frequency is modulated.

$$R = \frac{c}{4 s l o p e} ( {f}_{b d} + {f}_{b u} ) \qquad [ Equation 4 ]$$

$$v = \frac{λ}{4} ( {f}_{b d} - {f}_{b u} ) \qquad [ Equation 5 ]$$

In addition, referring to FIG. 1B, a transmission signal TS and a reception signal RS each having a non-linearly increasing and decreasing frequency are indicated with a one-dot chain line and a solid line, respectively. Unlike the theoretical description given with reference to FIG. 1A, it may be challenging for a LIDAR device to generate a perfectly linear transmission signal TS due to physical constraints such as temperature variations or noise.

When the frequency of the transmission signal TS projected from the LIDAR device toward the object increases or decreases non-linearly, the frequency of the reception signal RS reflecting from the object and returning to the LiDAR device may also change non-linearly. Consequently, a beat signal fb, generated by the interference between the transmission signal TS and the reception signal RS, may vary instead of remaining constant.

Referring to FIG. 1C, as the non-linearity of the transmission signal TS increases, the frequency bandwidth δf_{b} of the beat signal fb may become wider. For example, as the non-linearity of the transmission signal TS increases, a quality factor (Q factor) of the LiDAR device decreases.

When the non-linearity of the transmission signal TS increases, the spectrum peak width of the beat signal fb widens, and thus, it may be more difficult to accurately measure or extract the beat signal fb. As a result, the non-linearity of the transmission signal TS may degrade the signal-to-noise ratio (SNR) of the LiDAR device, thereby lowering the performance of the LiDAR device. For example, as the frequency of the transmission signal TS changes non-linearly over time, the precision of distance and velocity measurements of the LiDAR device may decrease. Alternatively, as the frequency of the transmission signal TS changes non-linearly over time, the maximum measurable distance of the LiDAR device may reduce.

The following description discusses about a configuration and operation method of a LiDAR device that are for improving the performance of the LiDAR device even when a transmission signal TS has a non-linearly increasing and decreasing frequency.

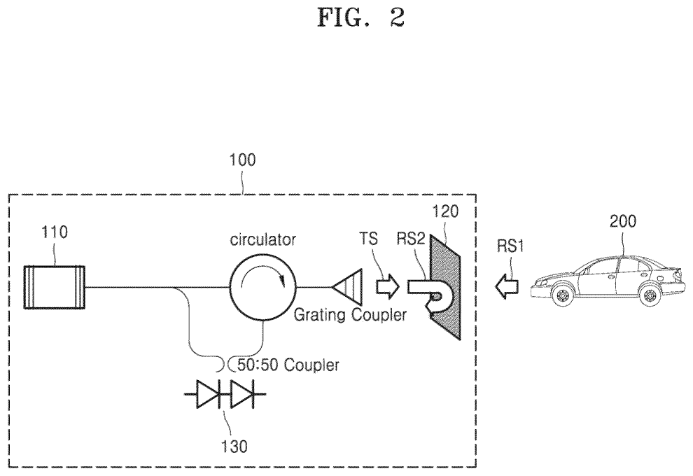

FIG. 2 is a view illustrating a LIDAR device 100 according to one or more embodiments. Referring to FIG. 2, the LiDAR device 100 of one or more embodiments may project or emit a transmission signal TS toward an object 200 and may then receive or detect a first reception signal RS1 reflected from the object 200 and a second reception signal RS2 reflected from an optical element 120.

The LiDAR device 100 may project the transmission signal TS toward the object 200 through a transmission unit. The transmission unit may project a transmission signal TS having a frequency-modulated continuous waveform toward the object 200. For example, the transmission unit may include a laser (light source) 110, a modulator, and an optical coupler (grating coupler).

The laser 110 may generate laser light of a specific wavelength. For example, the laser 110 may include a solid-state laser, but is not limited thereto. In another example, the laser 110 may include a laser diode, a fiber laser, or a vertical-cavity surface-emitting laser.

The modulator may modulate a transmission signal TS generated by the laser 110. For example, the modulator may modulate the frequency of the transmission signal TS to vary over time. Therefore, the frequency of the transmission signal TS may vary in a continuous form, increasing or decreasing over time. The transmission signal TS may be projected toward the object 200 to measure the distance to the object 200 and/or the velocity of the object 200 through the optical coupler.

However, subcomponents of the transmission unit are not limited to the examples described above. According to one or more embodiments, some components may be removed from the transmission unit or other components may be added to the transmission unit. Furthermore, although the subcomponents of the transmission unit are arbitrarily listed for ease of description, the subcomponents of the transmission unit may not be separated or distinguished from each other in terms of hardware. Moreover, in some embodiments, the subcomponents of the transmission unit may be included in other devices and may not be implemented by hardware included in the LiDAR device 100.

The LiDAR device 100 may include the optical element 120 disposed between the transmission unit and the object 200 and configured to partially reflect a transmission signal TS.

The optical element 120 may include a partial reflector to reflect a portion of a signal while allowing the remaining portion of the signal to pass through the optical element 120. For example, the partial reflector may include a glass or plastic material with a partial reflective coating. However, the partial reflector is not limited thereto. In another example, the partial reflector may include a dichroic mirror or a gas cell reflector.

The optical element 120 may be provided in a free space of the LiDAR device 100. For example, the optical element 120 may be placed in the free space of the LiDAR device 100 to allow a portion of a transmission signal TS to travel toward the object 200 through the optical element 120 while reflecting the remaining portion of the transmission signal TS toward a reception unit.

For example, the portion of the transmission signal TS projected toward the object 200 may pass through the optical element 120, reflect off the object 200, and form the first reception signal RS1, while the remaining portion of the transmission signal TS may reflect from the optical element 120 and form the second reception signal RS2.

The reception unit of the LiDAR device 100 may include at least one optical interferometer (which may be referred to as at least one optical coupler) and at least one photodetector (PD) 130. The reception unit may use the at least one optical interferometer and the at least one PD 130 to generate a first beat signal f1 and a second beat signal f2 based on the first reception signal RS1, the second reception signal RS2, and the transmission signal TS.

For example, the reception unit may include a first optical interferometer, a second optical interferometer, and a balanced PD (BPD). In this case, the PBD may include a pair of PDs.

The reception unit may use the first optical interferometer, the second optical interferometer, and the BPD to detect the first beat signal f1 based on the interference between the first reception signal RS1 and the transmission signal TS, and the second beat signal f2 based on the interference between the second reception signal RS2 and the transmission signal TS.

The reception unit may generate a first optical signal by mixing the first reception signal RS1 and the transmission signal TS using the first optical interferometer, and a second optical signal by mixing the second reception signal RS2 and the transmission signal TS using the second optical interferometer. The reception unit may convert, using the BPD, the first optical signal and the second optical signal respectively into electrical signals, that is, the first beat signal f1 and the second beat signal f2.

However, a number of optical interferometers included in the reception unit is not limited to the examples described above. In another example, the reception unit may include one optical interferometer and one BPD including a pair of PDs.

The reception unit may detect, using the optical interferometer and the BPD, the first beat signal f1 based on the interference between the first reception signal RS1 and the transmission signal TS, and the second beat signal f2 based on the interference between the second reception signal RS2 and the transmission signal TS.

For example, the optical interferometer of the reception unit may generate the first optical signal by mixing the first reception signal RS1 and the transmission signal TS, and the second optical signal by mixing the second reception signal RS2 and the transmission signal TS. The BPD of the reception unit may convert the first optical signal and the second optical signal respectively into electrical signals, that is, the first beat signal f1 and the second beat signal f2. For example, the reception unit may use one optical interferometer and one BPD to generate the first beat signal f1 and the second beat signal f2 based on the transmission signal TS, the first reception signal RS1, and the second reception signal RS2. The optical interferometer may receive a local oscillator signal (LOS) in a first direction and may receive the first reception signal RS1 and the second reception signal RS2 in a second direction opposite to the first direction. According to one or more embodiments, the term LOS may refer to a signal generated by the laser 110 and received by the optical interferometer in one direction. For ease of description, it is assumed that the LOS has the same or nearly the same frequency as the transmission signal TS. For example, the optical interferometer may receive the transmission signal TS in the first direction and the first and second reception signals RS1 and RS2 in the second direction opposite to the first direction.

The transmission signal TS may interfere with the first reception signal RS1 and the second reception signal RS2. For example, the transmission signal TS may interfere with each of the first reception signal RS1 and the second reception signal RS2, and thus, the optical interferometer may generate the first optical signal and the second optical signal as results of the interference.

As the transmission signal TS interferes with the first reception signal RS1 and the second reception signal RS2, the optical interferometer may generate the first optical signal and the second optical signal. For example, the first beat signal f1 may be generated by the interference between the transmission signal TS and the first reception signal RS1, and the second beat signal f2 may be generated by the interference between the transmission signal TS and the second reception signal RS2. Therefore, each of the first optical signal and the second optical signal may include the first beat signal f1 and the second beat signal f2.

The first beat signal f1 and the second beat signal f2 included in the first optical signal may respectively have the same intensity as the first beat signal f1 and the second beat signal f2 included in the second optical signal, but may have phases opposite to the phases of the first beat signal f1 and the second beat signal f2 included in the second optical signal. Therefore, the BPD may detect the first beat signal f1 and the second beat signal f2 by differencing the first optical signal and the second optical signal.

However, the configuration of the reception unit for coupling the first and second optical signals is not limited to the at least one optical coupler. In another example, the reception unit may generate the first and second optical signals using a beam splitter, and the BPD may detect the first beat signal f1 and the second beat signal f2 by differencing the first optical signal and the second optical signal.

Moreover, subcomponents of the reception unit are not limited to the examples described above. According to one or more embodiments, some components may be removed from the reception unit, or other components may be added to the reception unit. Furthermore, although the subcomponents of the reception unit are arbitrarily listed for ease of description, the subcomponents of the reception unit may not be separated or distinguished from each other in terms of hardware. Moreover, in some embodiments, the subcomponents of the reception unit may be included in other devices and may not be implemented by hardware included in the LiDAR device 100.

The LiDAR device 100 of one or more embodiments may further include a circulator. The circulator may be disposed in an optical path of the LiDAR device 100 to separate the transmission signal TS and the reception signal RS from each other for preventing mutual interference between the transmission signal TS and the reception signal RS. For example, when the transmission signal TS reaches the object 200 through a first path, each of the first reception signal RS1 and the second reception signal RS2 respectively reflecting from the object 200 and the optical element 120 may be received through a path different from the first path.

However, a configuration for separating traveling paths of the transmission signal TS, the first reception signal RS1, and the second reception signal RS2 is not limited to the circulator. In another example, the LiDAR device 100 may separate the traveling paths of signals using a beam splitter.

Although FIG. 2 illustrates one or more embodiments in which the optical element 120 is provided in the free space of the LiDAR device 100, the position of the optical element 120 is not limited thereto. In another example, the optical element 120 may be provided in an optical waveguide of the LiDAR device 100 or at a boundary between the optical waveguide and the free space.

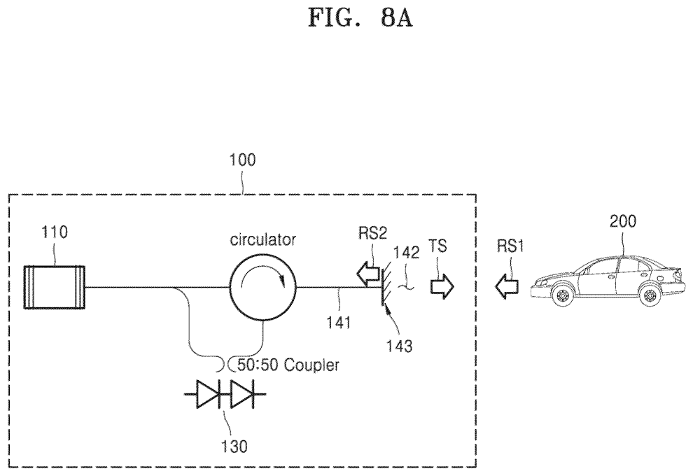

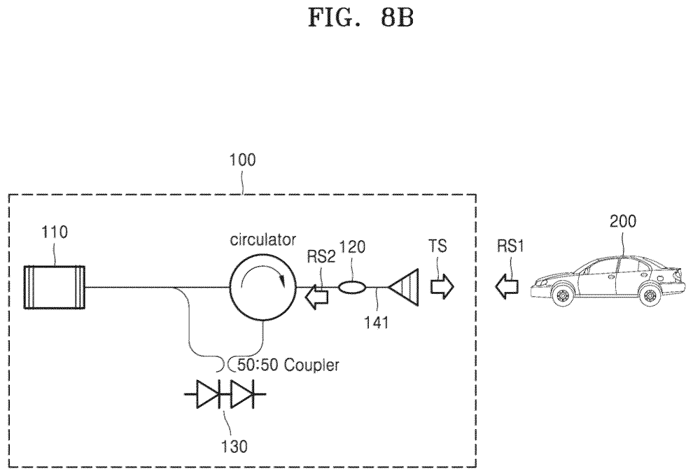

FIG. 8A is a view illustrating a LIDAR device 100 according to another embodiment, and FIG. 8B is a view illustrating a LIDAR device 100 according to yet another embodiment. The LiDAR devices 100 shown in FIGS. 8A and 8B are different from the LiDAR device 100 shown in FIG. 2 only in the position of an optical element, and the description of the LiDAR device 100 given with reference to FIG. 2 may also apply to the LiDAR devices 100 shown in FIGS. 8A and 8B.

Referring to FIG. 8A, the optical element may be provided at a boundary between an optical waveguide and a free space of the LiDAR device 100. For example, because the optical element is provided at the boundary between the optical waveguide and the free space, a portion of a transmission signal TS may pass through the optical element and travel toward an object 200, and the remaining portion of the transmission signal TS may reflect from the optical element and arrive at a reception unit along the optical waveguide.

For example, a portion of the transmission signal TS projected toward the object 200 along the optical waveguide may pass through the optical element, reflect from the object 200, and form a first reception signal RS1, while the remaining portion of the transmission signal TS may reflect from the optical element and form a second reception signal RS2 within the optical waveguide.

Referring to FIG. 8B, the optical element may be provided within an optical waveguide of the LiDAR device 100. Because the optical element is provided within the optical waveguide, a portion of a transmission signal TS projected toward the object 200 may pass through the optical element, reflect from the object 200, and form a first reception signal RS1, and the remaining portion of the transmission signal TS may reflect from the optical element and form a second reception signal RS2.

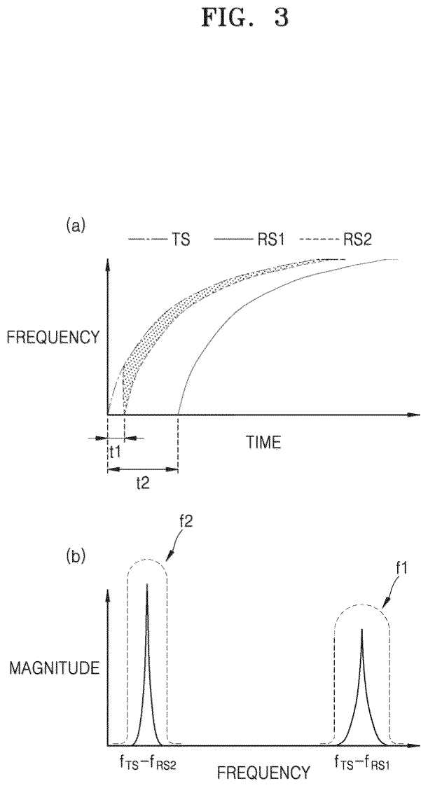

FIG. 3 is a set of graphs (a) and (b) illustrating a first reception signal RS1 and a second reception signal RS2 received by the LiDAR device 100 shown in FIG. 2, and a first beat signal f1 and a second beat signal f2 corresponding to the first reception signal RS1 and the second reception signal RS2.

For example, in graph (a) of FIG. 3, a transmission signal TS, the first reception signal RS1, and the second reception signal RS2, each having a non-linearly increasing and decreasing frequency, are denoted with a one-dot chain line, a solid line, and a dashed line, respectively. In addition, graph (b) of FIG. 3 shows the first beat signal f1 generated from the transmission signal TS and the first reception signal RS1, and the second beat signal f2 generated from the transmission signal TS and the second reception signal RS2.

Referring to graph (a) of FIG. 3, the first reception signal RS1 is received by the reception unit after a second delay time t2 has elapsed since the transmission signal TS was transmitted from the transmission unit, and the second reception signal RS2 is received by the reception unit after a first delay time t1 has elapsed since the transmission signal TS was transmitted from the transmission unit.

The reception unit may generate, using at least one optical interferometer, a first optical signal and a second optical signal based on the first delay time t1, the second delay time t2, and the Doppler effect between the LiDAR device 100 and the object 200.

For example, the reception unit may generate, using one optical interferometer, the first optical signal based on the second delay time t2 and the Doppler effect between the first reception signal RS1 and the transmission signal TS, and the second optical signal based on the first delay time t1 and the Doppler effect between the second reception signal RS2 and the transmission signal TS. However, the number of optical interferometers of the reception unit is not limited thereto. In one or more embodiments, the reception unit may generate, using two optical interferometers, the first optical signal and the second optical signal.

Referring to graph (b) of FIG. 3, in the same frequency domain, the first beat signal f1 may be detected in a relatively high frequency range, and the second beat signal f2 may be detected in a relatively low frequency range.

The reception unit may detect the first beat signal f1 and the second beat signal f2 using the at least one PD 130. For example, the reception unit may detect the first beat signal f1 and the second beat signal f2 in the same frequency domain using one BPD including a pair of PDs.

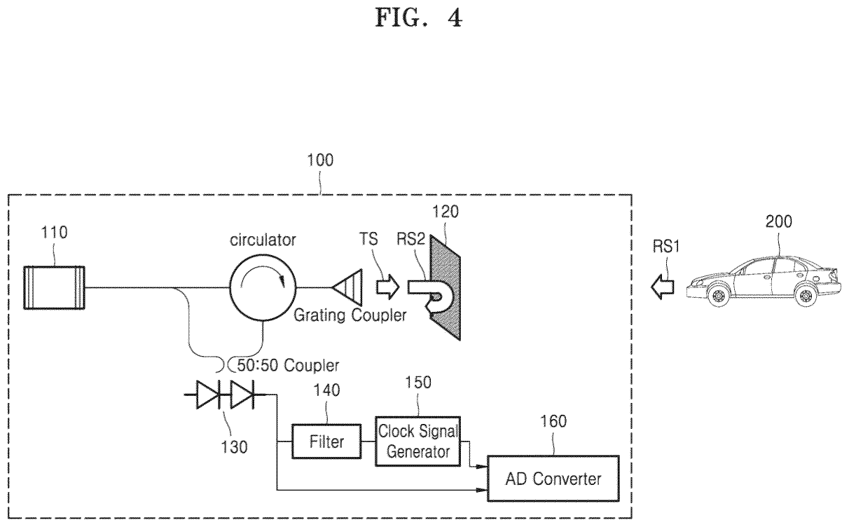

Hereinafter, a method for the LiDAR device 100 of FIG. 2 to correct the first beat signal f1 using the second beat signal f2 is described with reference to FIG. 4.

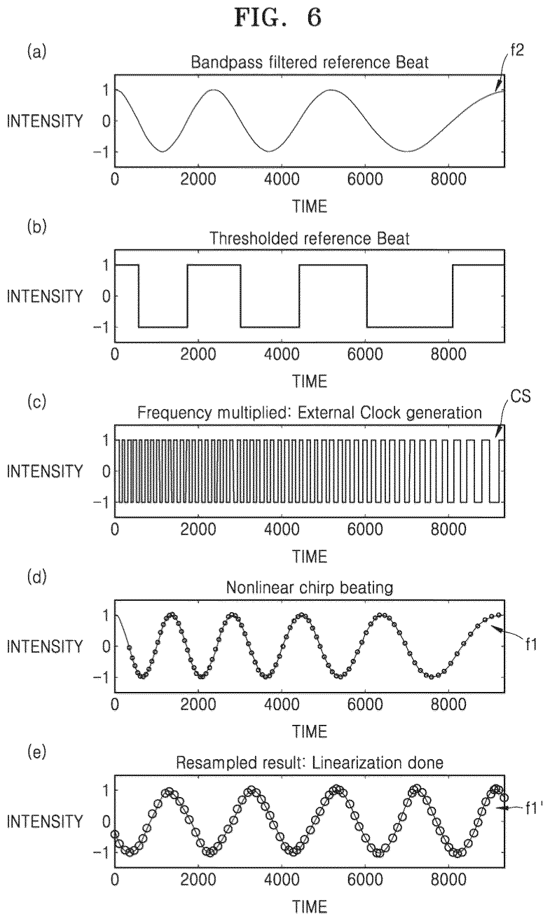

FIG. 4 is a view illustrating a method for the LiDAR device 100 shown in FIG. 2 to correct a first beat signal f1 by generating a clock signal CS. FIG. 6 is a set of graphs illustrating a method of correcting a first beat signal f1 by generating a clock signal CS.

Referring to FIG. 4, the reception unit of the LiDAR device 100 may further include a filter 140, a clock signal generator 150, and an analog-to-digital (AD) converter 160. In addition, referring to FIG. 6, graph (a) illustrates a second beat signal f2 extracted by the filter 140, graph (c) illustrates a clock signal CS generated by the clock signal generator 150, and graph (e) illustrates a corrected first beat signal f1′ generated by the AD converter 160.

The filter 140 may separate, by frequency band, a first beat signal f1 and a second beat signal f2 that are detected in the same frequency domain. For example, the filter 140 may be a bandpass filter or a low-pass filter and may extract the second beat signal f2 from measurement results of the at least one PD 130.

However, the filtering frequency band of the filter 140 is not limited thereto. In another example, the filter 140 may be a bandpass filter or a high-pass filter and may extract the first beat signal f1 from measurement results of the at least one PD 130.

The clock signal generator 150 may generate a clock signal CS using the second beat signal f2 extracted by the filter 140. The clock signal generator 150 may include a component for thresholding the second beat signal f2 and/or a component for multiplying the frequency of the second beat signal f2. For example, a component for thresholding the second beat signal f2 may determine the high threshold level and the low threshold level of the second beat signal f2.

In an example, the clock signal generator 150 may generate the clock signal CS by thresholding the second beat signal f2 and then multiplying the frequency of the second beat signal f2. The clock signal generator 150 may convert the waveform of the second beat signal f2 from a sine waveform to a discrete pulse waveform and then generate the clock signal CS by multiplying the frequency of the second beat signal f2.

For example, the clock signal generator 150 may sample and quantize the second beat signal f2 having a sine waveform as shown in graph (a) of FIG. 6 to generate a pulse waveform having a second beat frequency as shown in graph (b) of FIG. 6. The clock signal generator 150 may multiply the frequency of the second beat signal f2 to generate the clock signal CS as shown in graph (c) of FIG. 6 for correcting the first beat signal f1 shown in graph (d) of FIG. 6.

In another example, the clock signal generator 150 may generate the clock signal CS by multiplying the frequency of the second beat signal f2 and then thresholding the second beat signal f2. The clock signal generator 150 may first increase the frequency of the second beat signal f2. Then, the clock signal generator 150 may convert the waveform of the frequency-increased second beat signal f2 from a sine waveform to a pulse waveform.

For example, the clock signal generator 150 may sample and quantize the second beat signal f2 of which the frequency is multiplied, thereby converting the waveform of the second beat signal f2 from a sine form into a pulse form. Thus, the clock signal generator 150 may generate the clock signal CS for correcting the first beat signal f1.

The AD converter 160 may correct the first beat signal f1 using the clock signal CS generated by the clock signal generator 150. For example, the AD converter 160 may be a data acquisition (DAQ) interface. The AD converter 160 may generate the corrected first beat signal f1′ shown in graph (e) of FIG. 6 by using the clock signal CS shown in graph (c) of FIG. 6.

In an example, the AD converter 160 may generate the corrected first beat signal f1′ by using the clock signal CS generated by the clock signal generator 150 to reduce or eliminate distortion from the first beat signal f1 extracted by the filter 140.

For example, to prevent phase information distortion of the first beat signal f1, the AD converter 160 may adjust sampling timing by detecting zero-crossings through the matching of the clock signal CS shown in graph (c) of FIG. 6 and the first beat signal f1 shown in graph (d) of FIG. 6. According to one or more embodiments, sampling timing may refer to the moment (time point) when a signal is read. The AD converter 160 may detect a more accurate sampling timing of the first beat signal f1 to higher accuracy synchronization between the clock signal CS and the first beat signal f1 and may thus generate the corrected first beat signal f1′ shown in graph (e) of FIG. 6.

In another example, the AD converter 160 may correct the first beat signal f1 by reducing or eliminating distortion in measurement results of the at least one PD 130 using a clock signal generated by the clock signal generator 150.

For example, the AD converter 160 may adjust sampling timing to prevent phase information distortion of the first beat signal f1. To this end, the AD converter 160 may detect zero-crossings by matching the clock signal CS with the first beat signal f1 and the second beat signal f2 that are detected in the same frequency domain. The AD converter 160 may achieve higher accuracy synchronization between the clock signal CS and the first beat signal f1 by detecting precise sampling timing of the first beat signal f1, thereby generating the corrected first beat signal f1′ shown in graph (e) of FIG. 6.

In addition, the configuration of the reception unit of the LiDAR device 100 for correcting the first beat signal f1 by generating the clock signal CS is not limited to the examples described above. In one or more embodiments, the reception unit of the LiDAR device 100 may generate the clock signal CS and correct the first beat signal f1 by using only the AD converter 160. In this case, the AD converter 160 may be a DAQ interface having a relatively high processing rate.

The AD converter 160 may convert measurement results of the at least one PD 130 into a digital signal and may then extract the first beat signal f1 and the second beat signal f2 using a software filter. The AD converter 160 may correct the first beat signal f1 based on the extracted second beat signal f2.

For example, the AD converter 160 may oversample measurement results of the at least one PD 130. According to one or more embodiments, oversampling may refer to sampling a signal at a relatively high sampling rate. For example, oversampling may refer to acquiring more data that sufficient data acquired for sampling of a signal to be measured.

The AD converter 160 may apply a software filter to a digital signal obtained through oversampling at a relatively high sampling rate to extract the first beat signal f1 and the second beat signal f2. Thereafter, the AD converter 160 may correct the first beat signal f1 by resampling the first beat signal f1 to minimize frequency dispersion of the second beat signal f2.

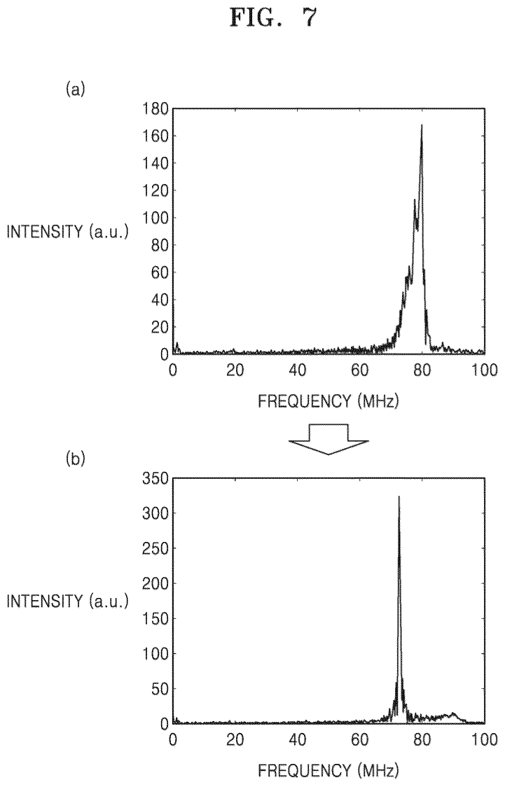

FIG. 7 is a set of graphs illustrating characteristics of a first beat signal f1 before and after the first beat signal f1 is corrected. For example, graph (a) of FIG. 7 shows the first beat signal f1 in an uncorrected state, and graph (b) of FIG. 7 shows the first beat signal f1 in a corrected state (corrected first beat signal f1′).

Referring to FIG. 7, the frequency bandwidth of the first beat signal f1 shown in graph (a) is greater than the frequency bandwidth of the corrected first beat signal f1′ shown in graph (b). That is, the quality factor of the LiDAR device 100 may be improved by resampling the first beat signal f1 based on a second beat signal f2.

The LiDAR device 100 of one or more embodiments includes the optical element 120, and may thus receive a first reception signal RS1 reflected from the object 200 and a second reception signal RS2 reflected from the optical element 120. Therefore, even when a transmission signal TS has a non-linearly increasing and decreasing frequency, the performance of the LiDAR device 100 of the one or more embodiments may be improved by correcting the first beat signal f1 based on the second beat signal f2.

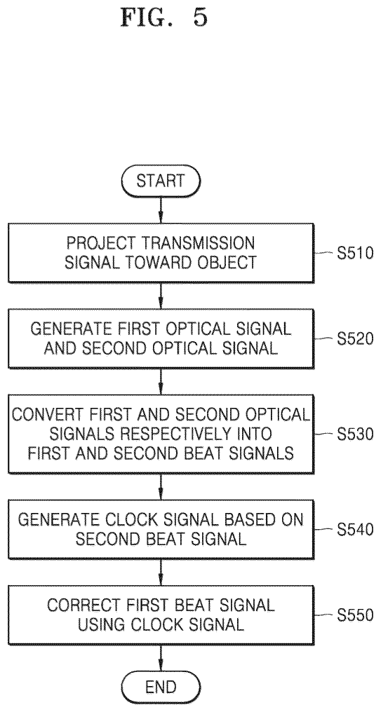

FIG. 5 is a flowchart illustrating a method of operating a LIDAR device, according to one or more embodiments. Referring to FIG. 5, the operating method of the one or more embodiments may include operations that are performed by the LIDAR device 100 described with reference to FIGS. 1A to 1C, FIGS. 2 to 4, and FIGS. 6 and 7. Therefore, the description of the LiDAR device 100 provided above with reference to FIGS. 1A to 1C, FIGS. 2 to 4, and FIGS. 6 and 7 may also apply to the operating method illustrated in FIG. 5.

In S510, the LiDAR device 100 may project a transmission signal TS toward an object 200 using the transmission unit. The transmission unit may project a transmission signal TS, which has a frequency-modulated continuous waveform, toward the object 200.

For example, the transmission unit may include the laser 110, the modulator, and the optical coupler. The transmission unit may generate laser light of a specific wavelength using the laser 110 and may modulate the transmission signal TS generated by the laser 110 using the modulator. The transmission unit may modulate the transmission signal TS using the modulator such that the frequency of the transmission signal TS may vary over time. Then, the transmission unit may project the transmission signal TS toward the object 200 by using the optical coupler to measure the distance to the object 200 and/or the velocity of the object 200.

The LiDAR device 100 may include the optical element 120 provided between the transmission unit and the object 200 to partially reflect the transmission signal TS. For example, the optical element 120 may be provided in the free space of the LiDAR device 100 to allow a portion of the transmission signal TS to travel toward the object 200 through the optical element 120 while reflecting the remaining portion of the transmission signal TS toward the reception unit.

Therefore, the portion of the transmission signal TS projected toward the object 200 may pass through the optical element 120, reflect off the object 200, and form a first reception signal RS1, while the remaining portion of the transmission signal TS may reflect from the optical element 120 and form a second reception signal RS2.

However, the position of the optical element 120 is not limited to the free space of the LiDAR device 100. In another example, the optical element 120 may be provided within the optical waveguide of the LiDAR device 100 or at the boundary between the optical waveguide and the free space.

In S520, the LiDAR device 100 may generate, using at least one optical interferometer, a first optical signal by mixing the first reception signal RS1 and the transmission signal TS, and a second optical signal by mixing the second reception signal RS2 and the transmission signal TS.

In S530, the LiDAR device 100 may convert, using the at least one PD 130, the first optical signal and the second optical signal respectively into electrical signals, that is, a first beat signal f1 and a second beat signal f2.

For example, the LiDAR device 100 may include one optical interferometer and one BPD. In this case, the LiDAR device 100 may generate, using the optical interferometer, the first optical signal and the second optical signal that are results of interference between the transmission signal TS, the first reception signal RS1, and the second reception signal RS2.

The transmission signal TS may interfere with the first reception signal RS1 and the second reception signal RS2. For example, the transmission signal TS may interfere with each of the first reception signal RS1 and the second reception signal RS2. Therefore, the LiDAR device 100 may generate the first optical signal and the second optical signal using a single optical interferometer.

The first beat signal f1 may be generated by the interference between the transmission signal TS and the first reception signal RS1, and the second beat signal f2 may be generated by the interference between the transmission signal TS and the second reception signal RS2. Therefore, the LiDAR device 100 may detect the first beat signal f1 and the second beat signal f2 by differencing the first optical signal and the second optical signal using one BPD.

However, a number of optical interferometers is not limited to the examples described above. In another example, the LiDAR device 100 may include two optical interferometers and one BPD including a pair of PDs.

In addition, the LiDAR device 100 may further include the circulator. The circulator may be provided in the optical path of the LiDAR device 100 to separate a transmission signal TS and a reception signal RS from each other for preventing interference between the transmission signal TS and the reception signal RS. For example, when the transmission signal TS reaches the object 200 along one path, the first reception signal RS1 and the second reception signal RS2, respectively reflected from the object 200 and the optical element 120, may be received via different paths using the circulator.

However, a component for separating the traveling paths of the transmission signal TS, the first reception signal RS1, and the second reception signal RS2 is not limited to the circulator. In another example, the LiDAR device 100 may use a beam splitter to separate the traveling paths of signals.

In S540, the LiDAR device 100 may generate a clock signal CS based on the second beat signal f2. The LiDAR device 100 may further include the filter 140, the clock signal generator 150, and the AD converter 160.

The LiDAR device 100 may use the filter 140 to separate the first beat signal f1 and the second beat signal f2 by frequency band. For example, the filter 140 may be a bandpass filter or a low-pass filter, and the LiDAR device 100 may extract the second beat signal f2 from measurement results of the at least one PD 130.

In another example, the filter 140 may be a bandpass filter or a high-pass filter, and the LiDAR device 100 may extract the first beat signal f1 from measurement results of the at least one PD 130.

The LiDAR device 100 may use the clock signal generator 150 to generate the clock signal CS based on the extracted second beat signal f2.

For example, the LiDAR device 100 may use the clock signal generator 150 to generate the clock signal CS by thresholding the second beat signal f2 and then multiplying the frequency of the second beat signal f2. The clock signal generator 150 may generate the clock signal CS by converting the waveform of the second beat signal f2 from a sine waveform to a discrete pulse waveform and then multiplying the frequency of the second beat signal f2.

In another example, the LiDAR device 100 may use the clock signal generator 150 to generate the clock signal CS by multiplying the frequency of the second beat signal f2 and then thresholding the second beat signal f2.

In S550, the LiDAR device 100 may correct the first beat signal f1 using the clock signal CS.

For example, the LiDAR device 100 may use the AD converter 160 to detect zero-crossings by matching the clock signal CS generated by the clock signal generator 150 to the first beat signal f1. Through this, the LiDAR device 100 may adjust sampling timing to prevent phase information distortion of the first beat signal f1. The LIDAR device 100 may achieve higher accuracy synchronization between the clock signal CS and the first beat signal f1 by detecting precise sampling timing of the first beat signal f1. As a result, the LiDAR device 100 may generate a corrected first beat signal f1′.

In another example, the LiDAR device 100 may use the AD converter 160 to correct the first beat signal f1 by reducing or eliminating distortion from measurement results of the at least one PD 130 using the clock signal CS generated by the clock signal generator 150.

The LiDAR device 100 may extract the corrected first beat signal f1′ using the filter 140 and may determine the distance to the object 200 and/or the velocity of the object 200 using the corrected first beat signal f1′.

According to the operating method of one or more embodiments, the LIDAR device 100 may receive, using the optical element 120, the first reception signal RS1 reflected from the object 200 and the second reception signal RS2 reflected from the optical element 120. Therefore, even when the transmission signal TS has a non-linearly increasing and decreasing frequency, the operating method of one or more embodiments may improve the performance of the LiDAR device 100 by correcting the first beat signal f1 based on the second beat signal f2.

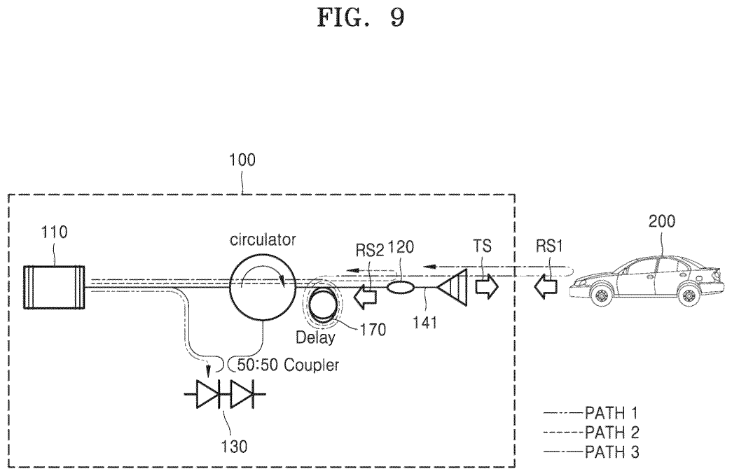

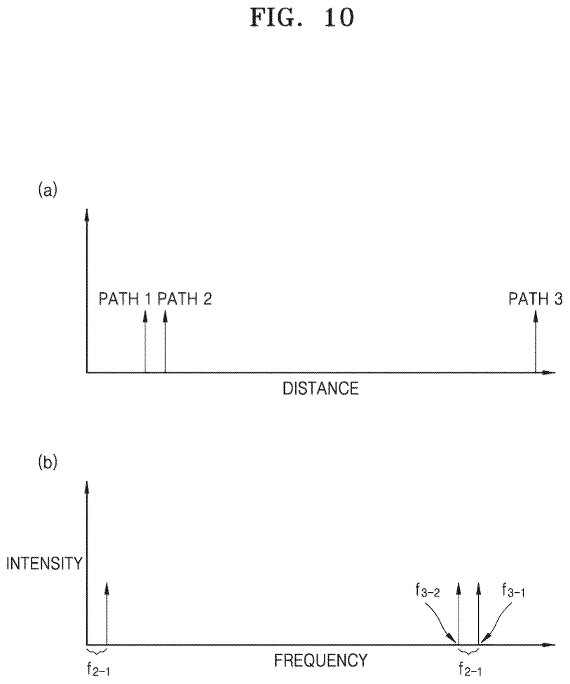

FIG. 9 is a view illustrating the LiDAR device 100 of FIG. 8B with an added optical delay line 170, and FIG. 10 is a set of graphs illustrating characteristics of a beat signal generated in the LiDAR device 100 shown in FIG. 9.

Referring to FIG. 9, the LiDAR device 100 may further include the optical delay line 170. The optical element 120 is provided in the optical waveguide of the LIDAR device 100, and thus, when a transmission signal TS is projected toward an object 200, a portion of the transmission signal TS may pass through the optical element 120, reflect from the object 200, and form a first reception signal RS1, and the remaining portion of the transmission signal TS may reflect from the optical element 120 and form a second reception signal RS2.

Referring to FIG. 9, an LOS may travel to the at least one PD 130 along a path 1 indicated with a two-dot chain line, the first reception signal RS1 may travel to the at least one PD 130 along a path 3 indicated with a one-dot chain line, and the second reception signal RS2 may travel to the at least one PD 130 along a path 2 indicated with a dashed line. For example, because the first reception signal RS1 and the second reception signal RS2 are formed via the optical delay line 170, optical paths of the first reception signal RS1 and the second reception signal RS2 may extend.

In general, the optical path of the second reception signal RS2 is shorter than the optical path of the first reception signal RS1, and thus, the intensity (or frequency) of a second beat signal f2 may be detected as relatively low. Because the LIDAR device 100 includes the optical delay line 170, the LiDAR device 100 may increase a second beat frequency, thereby more easily reducing or eliminating noise in a low-frequency range and detecting the second beat signal f2 with higher resolution.

However, as the second beat frequency increases, interference may occur between the second beat signal f2 and a first beat signal f1, potentially resulting in unintended ghost signals.

The LiDAR device 100 may vary power distribution to a first optical signal and a second optical signal using an optical coupler to remove unintended ghost signals. As another example, the LiDAR device 100 may remove unintended ghost signals by varying the ratio of transmission to reflection of the optical element 120. Alternatively, the LiDAR device 100 may further include a matched filter or a bandpass filter to remove unintended ghost signals.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A light detection and ranging (LiDAR) device comprising:
a transmission unit configured to project a transmission signal toward an object;
an optical element between the transmission unit and the object, the optical element being configured to partially reflect the transmission signal projected by the transmission unit;
a reception unit comprising:
at least one optical interferometer configured to generate a first optical signal by mixing a first reception signal reflected from the object with the transmission signal and a second optical signal by mixing a second reception signal reflected from the optical element with the transmission signal; and
at least one photodetector (PD) configured to convert the first optical signal and the second optical signal into a first beat signal and a second beat signal, respectively; and
a processor configured to generate a clock signal based on the second beat signal and correct the first beat signal based on the clock signal.

2. The LiDAR device of claim 1, wherein the processor is further configured to:
extract the second beat signal from measurement results of the at least one PD based on a bandpass filter or a low-pass filter; and
generate the clock signal based on the extracted second beat signal.

3. The LiDAR device of claim 2, wherein the processor is further configured to:
generate the clock signal by thresholding the extracted second beat signal and then multiplying a frequency of the extracted second beat signal.

4. The LiDAR device of claim 2, wherein the processor is further configured to generate the clock signal by multiplying a frequency of the extracted second beat and then thresholding the extracted second beat signal.

5. The LiDAR device of claim 1, wherein the processor is further configured to:
convert measurement results of the at least one PD into a digital signal;
extract the first beat signal and the second beat signal from the digital signal based on a software filter; and
correct the first beat signal based on the extracted second beat signal.

6. The LiDAR device of claim 1, wherein the processor is further configured to correct the first beat signal by removing, based on the clock signal, distortion from measurement results of the at least one PD.

7. The LiDAR device of claim 1, wherein the processor is further configured to control a bandpass filter or a high-pass filter to extract the first beat signal from measurement results of the at least one PD.

8. The LiDAR device of claim 7, wherein the processor is further configured to correct the extracted first beat signal by removing distortion from the extracted first beat signal based on the clock signal.

9. The LiDAR device of claim 1, wherein the reception unit further comprises an optical delay line configured to increase a frequency of the second beat signal.

10. The LiDAR device of claim 1, wherein the processor is further configured to measure at least one of a distance from the LiDAR device to the object and a velocity of the object based on the corrected first beat signal.

11. The LiDAR device of claim 1, wherein the transmission unit is further configured to modulate a frequency of the transmission signal.

12. A method of operating a light detection and ranging (LiDAR) device, the method comprising:
projecting, by a transmitting unit of the LiDAR device, a transmission signal toward an object;
generating, by at least one optical interferometer of the LiDAR device, a first optical signal by mixing a first reception signal reflected from the object with the transmission signal, and a second optical signal by mixing a second reception signal reflected from an optical element with the transmission signal;
converting, by at least one photodetector (PD) of the LiDAR device, the first optical signal and the second optical signal respectively into a first beat signal and a second beat signal;
generating a clock signal based on the second beat signal; and
correcting the first beat signal based on the clock signal,
wherein the optical element is between a transmission unit and the object, the optical element being configured to partially reflect the transmission signal.

13. The method of claim 12, wherein the generating of the clock signal based on the second beat signal comprises:
extracting, by a bandpass filter or a low-pass filter, the second beat signal from measurement results of the at least one PD; and
generating the clock signal based on the extracted second beat signal.

14. The method of claim 13, wherein the generating of the clock signal based on the extracted second beat signal is performed by thresholding the extracted second beat signal and then multiplying a frequency of the extracted second beat signal.

15. The method of claim 13, wherein the generating of the clock signal based on the extracted second beat signal is performed by multiplying a frequency of the extracted second beat signal and thresholding the extracted second beat signal.

16. The method of claim 12, wherein the correcting of the first beat signal based on the clock signal is performed by removing, based on the clock signal, distortion from measurement results of the at least one PD.

17. The method of claim 12, wherein the correcting of the first beat signal based on the clock signal comprises:
extracting, by a bandpass filter or a high-pass filter, the first beat signal from measurement results of the at least one PD; and
removing distortion from the extracted first beat signal based on the clock signal to correct the first beat signal.

18. The method of claim 12, further comprising increasing, by an optical delay line, a frequency of the second beat signal.

19. The method of claim 12, further comprising measuring at least one of a distance from the LiDAR device to the object and a velocity of the object based on the corrected first beat signal.

20. The method of claim 12, further comprising modulating a frequency of the transmission signal.
